(19) United States
(12) Patent Application Publication
(10) Pub. No.: US 2009/0024567 A1
(43) Pub. Date: Jan. 22, 2009

(54) PROFILE BASED SET OF PLANS FOR A DATABASE

(76) Inventor: Srinivas Gadde, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/780,632

(22) Filed: Jul. 20, 2007

(51) Int. Cl. G06F 17/30

(52) U.S. Cl. 707/2; 707/E17.017

(57) ABSTRACT

A method for selecting a plan for a query is disclosed. The steps of the method include using a current plan when a query is invoked, where the current plan has a corresponding current profile. Determining when the current profile is changed into a new profile. When the current profile has changed, comparing the new profile to a set of stored profiles. When the new profile matches one of a set of stored profiles, then set the new profile as the current profile. And set one of a set of stored plans that corresponds to the first stored profile, as the current plan. When the new profile does not match one of the set of stored profiles, then invoke an optimizer to determine a new plan for the new profile. Set the new profile as the current profile, set the new plan as the current plan, save the new plan into the set of stored plans, and save the new profile into the set of stored profiles.

### BACKGROUND

Databases store massive amounts of data. Users or database administrators (DBAs) query the data for information. The users typically structure the query using a database language, for example SQL. After the user submits the SQL query, the database system produces a corresponding physical plan for the query. The first step in this process is to translate the logical query from SQL into a query tree in logical algebra. This step is the done by the parser.

The next step is to translate the query tree in logical algebra into a physical plan. There are generally a large number of physical plans that can implement the query tree. The process of finding the best physical plan out of the large number of physical plans is called query optimization. That is, for some query execution performance measure (e.g. execution time), finding the plan with the best execution performance is query optimization. The goal is that the plan be optimal or near optimal within the search space of the optimizer.

The optimizer starts by copying the relational algebra query tree into its search space. The optimizer then expands the search space and finds the best plan. Currently, optimizers typically use estimates of cardinality when searching for the best plan. The cardinality of a set is a measure of the “number of elements of the set”. Finally, the optimizer copies the optimal physical plan out of its memo structure and sends it to the query execution engine. The query execution engine executes the plan using the relations in the stored database as input, and produces a table as an output.

Databases change over time. Users or DBA may change the profile of a schema by adding an alternate access path or removing it. Adding or removing alternate access paths may change which plan should be selected during query optimization. Current optimizers may not be able to invalidate a plan when a profile changes. Without the ability to change plans when a profile changes, the optimizer may selected a plan that is non-optimal.

### BRIEF DESCRIPTION OF THE DRAWINGS

FIG. 1 is a flow chart illustrating an embodiment for running a query in an example embodiment of the invention.

### DETAILED DESCRIPTION

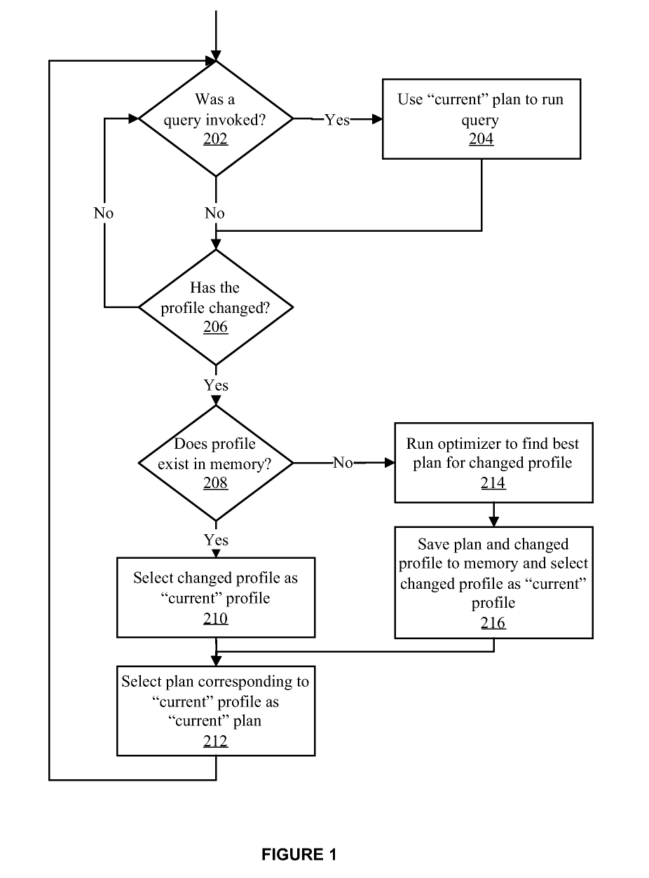

FIG. 1 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

Typically, when a user or DBA queries a database, the database management program calls an optimizer to determine a plan for executing the query. A plan is a complete description of how the query is to be physically executed. A plan is a set of directions that, when executed by a query execution engine, determines which algorithms to use, which access paths to use and in what order to perform the algorithms represented by the different physical operators. There are generally a large number of plans that can implement any given query. The optimizer searches through the set of plans that can implement the query, and selects the best plan.

The best plan is typically considered to be the plan that has the lowest cost. The cost for a plan is typically a measure of how quickly a plan will execute, with a low cost corresponding to a short execution time. However, the plan cost may be based on other, or additional, criteria, for example the amount of memory resources used by the plan. Execution time can be estimated by using a weighted sum of the predicted number of pages that will be fetched (the input/output (I/O) time) and the predicted number of instructions that will be executed (the computer processing time) when running the plan.

Invoking an optimizer uses time and resources. Each time the optimizer is executed or invoked, the optimizer determines a set of plans that can be executed to fulfill the query, calculates a cost for each of the plans, and then selects the best plan for the query. In one example embodiment of the invention, a set of plans and a corresponding set of plan profiles are stored in memory. Each one of the set of plans corresponds to a different plan profile. The “current” plan is the plan that corresponds to the current profile. When a user or DBA invokes a query, the current plan is used to run the query without invoking the optimizer. When the plan profile is changed, a different plan, out of the set of plans, is selected that corresponds to the changed profile. The different plan is also set as the “current” plan and then used to run the query. When the changed plan profile is completely new, and does not correspond to any of the stored plan profiles, the optimizer is invoked and a new plan is determined. The new plan and new profile are stored into memory. The new plan is selected as the “current” plan and used to run the query.

FIG. 1 is a flow chart illustrating an embodiment for running a query in an example embodiment of the invention. At step 202 a check is made to determine if a user or DBA has invoked a query. When a query has been invoked, the database management system uses the “current” plan to run the query at step 204. At step 206 a check is made to determine if the current profile has changed. When the profile has not changed, flow returns to step 202. When the profile has changed, the database management system compares the changed profile with the set of stored profiles at step 208. When the changed profile matches one of the stored profiles, the changed profile is selected as the “current” profile in step 210. The plan corresponding to the “current” profile is selected as the “current” plan in step 212. Flow then returns to step 202. When the changed profile does not match one of the stored profiles, the optimizer is invoked at step 214 to find the best plan for the changed profile. At step 216 the changed profile and the plan for the changed profile are saved in memory. The changed profile is also set as the “current” profile in step 216. The plan corresponding to the “current” profile is selected as the “current” plan in step 212. Flow then returns to step 202.

At step 208 when the new profile is compared to the set of profiles stored in memory, more than one stored profile may match the new profile (i.e. there may be overlap between some of the bounded parameters in the different profiles). Picking the stored profile with the best plan for the new profile may invoke the optimizer using only those plans that correspond to the matching profiles. Other plan matching techniques may use cardinality cutoffs to select the best plan out of the small set of plans that have profiles matching the new profile.

In one example embodiment of the invention, when the optimizer is invoked, the best plan for the changed profile may not be the only plan saved into the stored set of plans. In some cases the user or DBA may indicated a range of forecasted information for the profile, for example a range of forecasted cardinality or a number of forecasted access paths. When the optimizer is invoke, the optimizer will evaluate the best plan for the query under the current profile and will evaluate a set of plans using a set of profiles corresponding to the forecasted information. The best plan will be selected as the current plan and saved into the set of plans and the other forecasted plans may be saved into the set of plans with their corresponding profiles saved into the set of profiles. When the current profile is changed and the changed profile matches one of the forecasted profiles, the forecasted profile and its corresponding plan will already be stored in memory and the optimizer will not need to be invoked to determine the best plan for a query.

The profile for a plan is the set of bounded parameters under which the plan is valid. The set of bounded parameters may include: cardinality estimates ranges, a set of access paths, available memory, CPU availability, disk availability and the like. One example of a bounder parameter is a cardinality range between 1 and 100. As long as the profile stays within this cardinality range, the profile is still valid. When these bounded parameters are no longer satisfied then the profile is no longer valid and the profile has changed. The changed profile will use a different plan for the query.

Detecting when the profile changes can be done in a number of ways. In one example embodiment of the invention, a database trigger is used to detect when the profile changes. A database trigger is procedural code that is automatically executed in response to certain events on a particular table in a database. There are typically two classes of triggers: “row triggers” or “statement triggers”. With row triggers you can define an action for every row of a table, while statement triggers occur only once per INSERT, UPDATE, or DELETE statement. Each class can be of several types. There are “BEFORE triggers” and “AFTER triggers” which identifies the time of execution of the trigger. There is also an “INSTEAD OF trigger” which is a trigger that will execute instead of the triggering statement.

Users or DBAs can set a trigger to fire when one of the parameters for a plan is modified. The database management system would then check to see if the change caused one or more of the parameters to be set beyond the bounding area. When the parameters are still within the bounded area, the profile is still valid and the current plan can still be used. When a parameter changes such that it exceeds the bounded area, the profile is no longer valid and the profile is considered as a changed profile. The changed profile is checked against the set of stored profiles in memory. If a saved profile matches the changed profile, then the corresponding plan is set as the current plan and the changed profile is set as the current profile. When the profile does not match one of the stored profiles, the optimizer is invoked and a new plan corresponding to the changed profile is determined. The new plan is set as the current plan and the new plan and its corresponding profile are stored into the set of saved plans and saved profiles.

One of the hardest problems in query optimization is to accurately estimate the costs of alternative query plans. Optimizers cost query plans using a mathematical model of query execution costs that relies heavily on estimates of the cardinality, or number of tuples, flowing through each edge in a query plan. Cardinality estimation in turn depends on estimates of the selection factor of predicates in the query. Traditionally, database systems estimate selectivities through fairly detailed statistics on the distribution of values in each column, such as histograms. This technique works well for estimation of selectivities of individual predicates. However many queries have conjunctions of predicates such as select count(*) from R, S where R.make=‘Honda’ and R.model=‘Accord’. Query predicates are often highly correlated (for example, model=‘Accord’ implies make=‘Honda’), and it is very hard to estimate the selectivity of the conjunct in general. Poor cardinality estimates and uncaught correlation are one of the main reasons why query optimizers pick poor query plans. The estimates created using the mathematical models are typically called estimated statistics or estimated stats.

Once a query has been run, the actual numbers or real number for the cardinality of the tables will be known. These real time numbers are known as runtime stats. In one example embodiment of the invention, the runtime stats are used to calculate plans when a query is made using one or more tables from a previous query.

What is claimed is:

1. In a database program running on a computer system, a method for selecting a plan for a query, the steps of the method comprising:
using a current plan when a query is invoked, the current plan having a corresponding current profile;
determining when the current profile is changed into a new profile;
comparing the new profile to a set of stored profiles;
when the new profile matches a first one of the set of stored profiles:
set the new profile as the current profile and set a first one of a set of stored plans that corresponds to the first stored profile, as the current plan; and
when the new profile does not match one of the set of stored profiles:
invoke an optimizer to determine a new plan for the new profile, set the new profile as the current profile, set the new plan as the current plan, save the new plan into the set of stored plans, and save the new profile into the set of stored profiles.

2. The method of claim 1, wherein a trigger is used to determining when the profile is changed.

3. The method of claim 1, wherein the profile for the current plan is a set of bounded parameters under which the plan is valid.

4. The method of claim 3, wherein the set of bounded parameters comprise at least one of the following: cardinality estimates ranges, an access path, available memory, cpu availability, and disk availability.

5. The method of claim 1, further comprising:
determining a set of plans when the optimizer is invoked using a set of profiles corresponding to forecasted profile information;
saving the set of plans into the set of stored plans; and
saving the set of profiles into the set of stored profiles.

6. The method of claim 1, wherein the optimizer uses runtime stats to determine the new plan.

7. A computer software product that includes a medium readable by a processor, the medium having stored thereon, a method comprising:
using a current plan when a query is invoked, the current plan having a corresponding current profile;
determining when the current profile is changed into a new profile;
comparing the new profile to a set of stored profiles;
when the new profile matches a first one of the set of stored profiles:
set the new profile as the current profile and set a first one of a set of stored plans that corresponds to the first stored profile, as the current plan; and
when the new profile does not match one of the set of stored profiles:
invoke an optimizer to determine a new plan for the new profile, set the new profile as the current profile, set the new plan as the current plan, save the new plan into the set of stored plans, and save the new profile into the set of stored profiles.

8. The method of claim 7, wherein a trigger is used to determining when the profile is changed.

9. The method of claim 7, wherein the profile for the current plan is a set of bounded parameters under which the plan is valid.

10. The method of claim 9, wherein the set of bounded parameters comprise at least one of the following: cardinality estimates ranges, an access path, available memory, cpu availability, and disk availability.

11. The method of claim 7, further comprising:
determining a set of plans when the optimizer is invoked using a set of profiles corresponding to forecasted profile information;
saving the set of plans into the set of stored plans; and
saving the set of profiles into the set of stored profiles.

12. The method of claim 7, wherein the optimizer uses runtime stats to determine the new plan.

13. In a database program running on a computer system, a database management system used to select a plan for a query, the database management system comprising:
means for selecting a current plan when a query is invoked, the current plan having a corresponding current profile;
means for determining when the current profile is changed into a new profile;
means for comparing the new profile to a set of stored profiles, wherein the database management system sets the new profile as the current profile and sets a first one of a set of stored plans that corresponds to the first stored profile, as the current plan when the new profile matches a first one of the set of stored profiles; and
wherein the database management invokes an optimizer to determine a new plan for the new profile, sets the new profile as the current profile, sets the new plan as the current plan, saves the new plan into the set of stored plans, and saves the new profile into the set of stored profiles when the new profile does not match one of the set of stored profiles.
